(19) United States
(12) Patent Application Publication
(10) Pub. No.: US 2015/0101168 A1
(43) Pub. Date: Apr. 16, 2015

(54) APPARATUS AND METHOD FOR REMOVING A SHAFT

(71) Applicant: The Procter & Gamble Company, Cincinnati, OH (US)

(72) Inventor: Richard Allen TREPANIER, Little Suamico, WI (US)

(73) Assignee: The Procter & Gamble Company, Cincinnati, OH (US)

(21) Appl. No.: 14/053,888

(22) Filed: Oct. 15, 2013

(51) Int. Cl. B25B 27/00

(52) U.S. Cl. CPC B25B 27/00
USPC 29/426.5; 29/256

(57) ABSTRACT

An apparatus and method for extracting shafts is provided. The apparatus includes a torquing device, threaded rod, support frame, retractable portion, tensional coupler and collar. The torquing device is disposed on a first end of the threaded rod, and the threaded rod threads through a support frame and terminates at a second end that is in a rotatably free relationship with the retractable portion. The collar is connected to the retractable portion through the tensional coupler and is capable of grasping an engagement portion of the shaft. The method includes providing a shaft associated with an object, providing the apparatus, grasping the engagement portion of the shaft with the collar, positioning the support frame of the apparatus adjacent to a support wall and applying force while rotating the torquing device of the apparatus, resulting in the shaft being extracted.

### FIELD OF THE INVENTION

The present invention relates to a shaft extractor and method for extracting a shaft, and more particularly a shaft extracting apparatus and method for extracting long, delicate shafts.

### BACKGROUND OF THE INVENTION

Machines often require the attachment or placement of a shaft to serve as an arm, spindle, extension or other function. These shafts can be secured tightly, at times even pressure fitted, within the machine. Removal of shafts may be necessary for a variety of reasons such as cleaning, maintenance and design changes. Yet, removal can prove challenging when shafts are tightly secured within or to their respective machines.

In the tissue towel industry, shafts in the form of mandrels are utilized at various stages of the papermaking process. For example, mandrels are attached to an unwind stand and serve as a location for the core of a roll of a convolutely wound roll of paper. The unwind stand drives the mandrel in a rotatable manner, and the paper is wound about the core. The mandrels in this case are often small in diameter due to the typical diameters of paper towel and bath tissue cores. In addition, the mandrels are often very long to complement the length of the parent roll core. Moreover, due to the design of unwind stands, the mandrels are relatively light in weight and delicate. In some cases, they are made of fiberglass. Further, mandrels can be mounted to unwind stands with very close tolerances to facilitate inflation of an unwind stand's drive bladder around the mandrel, allowing the drive bladder to effectively grip the core as the mandrel rotates. The combination of these design elements and close tolerances makes removal of a mandrel from an unwind stand (or like machine) particularly difficult.

Indeed, known shaft and mandrel pullers fall short in ensuring the safe and efficient removal of mandrels on papermaking machines as they are not designed to account for their length and delicate nature. In some instances, removal of such mandrels requires at least three individuals and 2-4 hours of manual work. One individual may be knocking or otherwise loosening the mandrel from the machine with a hammer, crowbar or like tool, while two others hold the mandrel at different points for stability and to ensure it does not fall upon being loosened. Not only does this place individuals in a potentially unsafe situation, but the mandrel itself, which can be quite expensive, is at risk of being damaged or broken.

Thus, there is a need for an apparatus and method that facilitates the removal of long shafts such as mandrels in a more efficient and effective manner. Indeed, there is a need to reduce the manpower, physical effort and time required to remove such a shaft. Further, there is a need to increase safety in the removal process by minimizing human contact with the shaft and manual exertion such as pulling or hammering.

### SUMMARY OF THE INVENTION

The present invention addresses the need for an apparatus and method that efficiently and effectively removes long, delicate shafts from objects, reducing the time required to less than a half hour and minimizing manual effort. In one nonlimiting example of the present invention, an apparatus comprising a torquing device, threaded rod, support frame, retractable portion, tensional coupler and collar is provided. The torquing device is disposed on a first end of the threaded rod, and the threaded rod threads through a support frame and terminates at a second end that is in a rotatably free relationship with the retractable portion. The collar is connected to the retractable portion through the tensional coupler and is capable of grasping an engagement portion of the shaft.

In another embodiment, a method for extracting a shaft from an object is disclosed, the method comprising the steps of:
a. providing the shaft associated with the object, wherein the shaft comprises an engagement portion;
b. providing an apparatus comprising a torquing device, a threaded rod, a support frame, a retractable portion, tensional coupler and a collar, wherein:
   the torquing device is disposed on a first end of the threaded rod,
   the threaded rod threads through a support frame and terminates at a second end,
   the second end is in a rotatably free relationship with the retractable portion, and
   the collar is connected with the retractable portion through the tensional coupler;
c. grasping the engagement portion with the collar;
d. positioning the support frame adjacent to a support wall; and
e. applying force to the support frame in a first direction and rotating the torquing device, such that the threaded rod rotates and the threaded rod and the retractable portion move in a second direction, wherein the second direction is substantially opposite to the first direction, and wherein the tensional coupler pulls the collar in the second direction.

### BRIEF DESCRIPTION OF THE DRAWINGS

The above-mentioned and other features and advantages of the present disclosure, and the manner of attaining them, will become more apparent and the disclosure itself will be better understood by reference to the following description of non-limiting embodiments of the disclosure taken in conjunction with the accompanying drawings, wherein:

FIG. 1 is a perspective view an apparatus, shaft and object in accordance with one embodiment of the present invention;

FIG. 2 is a perspective view of an apparatus in accordance with an embodiment of the present invention;

FIG. 3 is a side elevation view of a shaft in accordance with one embodiment of the present invention;

FIG. 4 is a front view of the shaft of FIG. 3 along line 4-4;

FIG. 5 is a plan view of an apparatus, shaft and object in accordance with one embodiment of the present invention;

FIG. 6 is a partial view of the apparatus according to an embodiment of the present invention;

FIG. 7 is a partial view of an apparatus according to another embodiment of the present invention;

FIG. 8 is a perspective view of an apparatus in accordance with an alternative embodiment of the present invention;

FIG. 9 is a flowchart describing a method for extracting a shaft from an object according to an embodiment of the present invention;

FIG. 10 is a flowchart describing a method for extracting a shaft from an object according to another embodiment of the present invention;

FIG. 11 is a flowchart describing a method for extracting a shaft from an object according to an alternative embodiment of the present invention;

FIG. 12 is a flowchart describing a method for extracting a shaft from an object according to yet another embodiment of the present invention; and

FIG. 13 is a flowchart describing a method for extracting a shaft from an object according to still another embodiment of the present invention.

### DETAILED DESCRIPTION OF THE INVENTION

The present disclosure provides for equipment and methods for extracting a shaft from an object. Various nonlimiting embodiments of the present disclosure will now be described to provide an overall understanding of the principles of the function, design and use of the shaft extractor and methods disclosed herein. One or more examples of these nonlimiting embodiments are illustrated in the accompanying drawings. Those of ordinary skill in the art will understand that the apparatuses and methods described herein and illustrated in the accompanying drawings are nonlimiting example embodiments and that the scope of the various nonlimiting embodiments of the present disclosure are defined solely by the claims. The features illustrated or described in connection with one nonlimiting embodiment can be combined with the features of other nonlimiting embodiments. Such modifications and variations are intended to be included within the scope of the present disclosure.

### DEFINITIONS

“Shaft” as used herein means an elongate article, including but not limited to a rod, pole, mandrel, or spindle. A shaft of the present disclosure may be any suitable shape about its circumference. In one nonlimiting example, the shaft is cylindrical or substantially cylindrical. In another nonlimiting example, the shaft is prismatic or substantially prismatic. The shaft may be hollow or non-hollow, or combinations thereof. For ease of description herein, the shaft of the present disclosure can be viewed on a Cartesian coordinate system such that its length, L, is measured in the x-direction. The shaft's diameter and/or circumference and/or perimeter may be uniform or non-uniform throughout the length of the shaft.

“Fibrous structure” as used herein is a structure that comprises one or more fibers. Non-limiting examples of fibrous structures may include paper, fabrics and absorbent pads. Paper includes tissue paper commonly marketed as bath tissue or paper towels.

“Fibrous structure making process” as used herein is any process for making fibrous structures and/or converting fibrous structures into finished consumer products. Non-limiting examples of processes for making fibrous structures include wet-laid processes, air-laid processes, spun-bond processes, weaving processes, melt-blown processes and extrusion processes. Some processes may include steps of preparing a fiber composition in the form of a suspension in a medium, either wet, more specifically aqueous medium, or dry, more specifically gaseous, i.e. with air as medium. The aqueous medium used for wet-laid processes is oftentimes referred to as a fiber slurry. The fibrous slurry is then used to deposit a plurality of fibers onto a forming wire or belt such that an embryonic fibrous structure is formed, after which drying and/or bonding the fibers together results in a fibrous structure. Nonlimiting examples of converting processes for fibrous structures include winding and unwinding, cutting, transfer and tail gluing, ply bonding and embossing.

### Overview

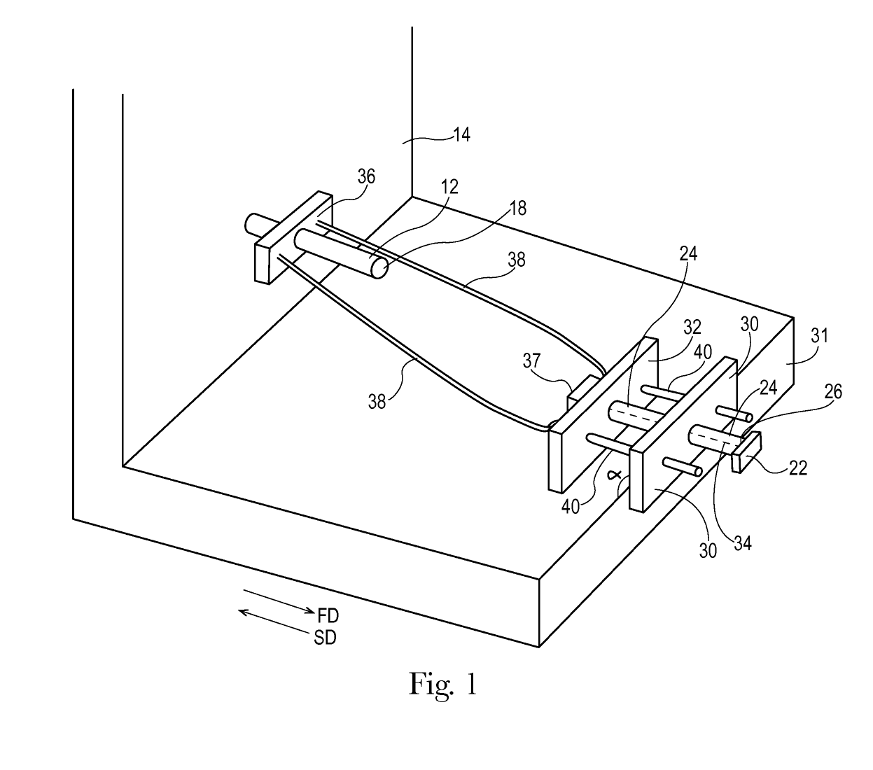

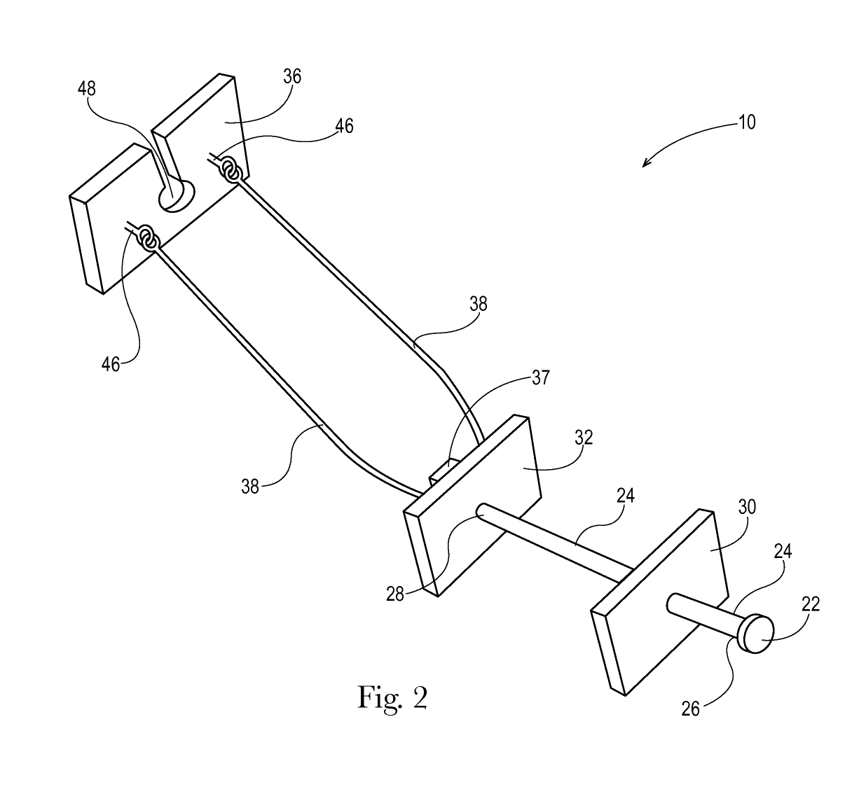

FIGS. 1 and 2 depict nonlimiting examples of an apparatus 10 for extracting a shaft 12 from an object 14, which can be a portion of a papermaking machine or converting machine. As illustrated in FIG. 2, the apparatus 10 may comprise a torquing device 22 such as a nut that can be turned with a wrench, a threaded rod 24, a support frame 30, a retractable portion 32, a collar 36 and a tensional coupler 38. In an embodiment, the torquing device 22 is generally disposed on the first end 26 of the threaded rod 24. The threaded rod 24 threads through the support frame 30 and terminates at a second end 28, and the second end 28 may be in a rotatably free relationship with the retractable portion 32. The retractable portion 32 is connected to the collar 36 through the tensional coupler 38. The collar 36 is capable of grasping or otherwise associating with the shaft 12 at an engagement portion 20.

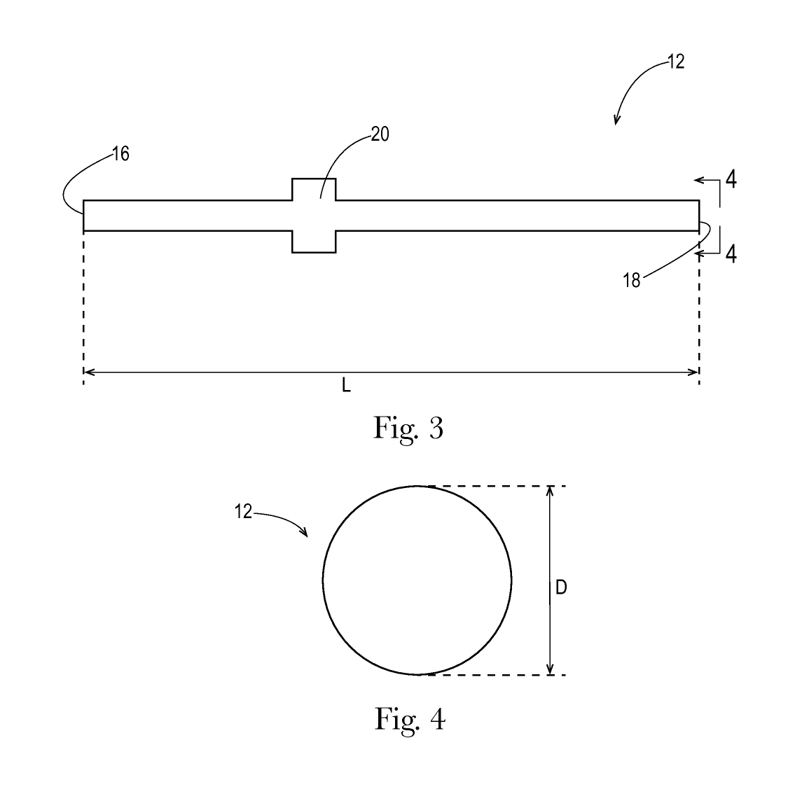

As shown in FIG. 3, the shaft 12 of the present invention may comprise a proximal end 16, which is attached or capable of being attached to an object 14, and a distal end 18 which may be free from attachment. In one nonlimiting example, the engagement portion 20 is located closer to the proximal end 16 than the distal end 18.

The engagement portion 20 may be integral with the shaft 12 or a separate piece joined to the shaft 12. As further shown in FIG. 3, the engagement portion 20 may comprise a cross-sectional area that is greater, e.g., larger in diameter, than the cross-sectional area of a portion of the shaft 12 immediately adjacent to the engagement portion 20. In an alternative embodiment, the engagement portion 20 may comprise an cross-sectional area that is smaller than the cross-sectional area of a portion of the shaft 12 immediately adjacent to the engagement portion 20. Likewise, the engagement portion 20 may comprise a circumference that is larger than or smaller than the circumference and/or perimeter of a portion of the shaft 12 immediately adjacent to the engagement portion 20. Similarly, the engagement portion 20 may comprise a diameter that is greater than or less than the diameter of a portion of the shaft 12 immediately adjacent to the engagement portion 20. In yet another embodiment, the engagement portion 20 may comprise an cross-sectional area that is substantially the same as the cross-sectional area of a portion of the shaft 12 immediately adjacent to the engagement portion 20. Likewise, the engagement portion 20 may comprise a circumference, perimeter and/or diameter that is substantially the same as that of a portion of the shaft 12 immediately adjacent to the engagement portion 20. In a further embodiment, the engagement portion 20 may have a substantially smooth surface, or substantially rough and/or uneven surface, or a combination of thereof. The engagement portion 20 may comprise the same surface texture as a portion of the shaft 12 immediately adjacent to the engagement portion 20, or the engagement portion 20 may comprise a surface texture different from that of a portion of the shaft 12 immediately adjacent to the engagement portion 20. In another nonlimiting example, the engagement portion 20 comprises a material different from another portion of the shaft 12.

In an embodiment, the shaft has a length, L, of about 100 inches or about 103 inches. In one nonlimiting example, shown in FIGS. 3 and 4, the shaft 12 is substantially cylindrical. In a further nonlimiting example, the shaft has a diameter, D, at its distal end 18 of about 40 mm. In yet another nonlimiting example, the distal end 18 is substantially conical and the diameter, D, may be taken at the base the conical shape, i.e., the portion of the conical shape with the largest diameter. For ease of description herein, with respect to FIGS. 3 and 4, the shaft of the present disclosure can be viewed on a Cartesian coordinate system such that its length, L, is measured in the x-direction and its diameter and/or perimeter, at any point along its length, L, is measured in the y-z plane.

In yet another embodiment, the shaft 12 may be made from fiberglass.

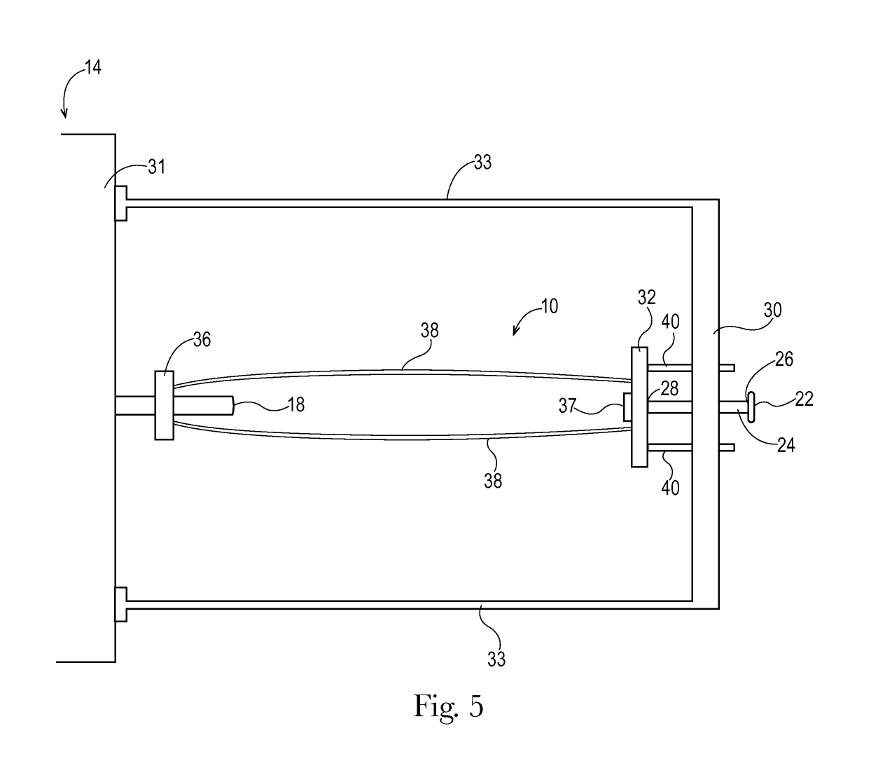

As can be seen in FIGS. 1 and 5, the shaft 12 may be associated with an object 14 such as a wall or other relatively immovable portion of a papermaking machine. The object 14 may comprise a generally vertical surface of a wall, machine or other structure capable of associating with a shaft 12. The shaft 12 and the object 14 may be associated by any manner suitable for use of the present invention. In one nonlimiting example, the shaft 12 is pressure fitted with the object 14. Alternatively, the shaft 12 may be secured through an opening in the object 14. Those of skill in the art will readily recognize suitable ways in which a shaft 12 may be associated with an object 14 as applicable to the present disclosure.

In one embodiment, the shaft 12 comprises a mandrel, such as a mandrel utilized in papermaking converting operations. In a further embodiment, the object 14 may comprise a machine used in a fibrous structure making process, such as a papermaking process. In one nonlimiting example, the object 14 may comprise an unwind stand used to wind paper from a parent roll onto a core to produce a “log” of rolled product that will subsequently be cut to appropriate lengths for consumer use. U.S. Pat. No. 5,660,350 to Byrne et al. discloses one nonlimiting example of a web winding machine suitable as an object 14 for the present invention. Another nonlimiting example of an object 14 suitable for the present invention is the Unwinder Model 375, commercially available from Fabio Perini S.p.A. One of skill in the art will recognize that the object 14 may comprise any structure or item capable of connecting with, securing, housing or otherwise having a shaft 12 associated with it, including but not limited to machines, turret assemblies, tools, walls and the like.

### Apparatus for Extracting the Shaft

Returning to FIGS. 1 and 2, an apparatus 10 for extracting a shaft 12 from an object 14 is provided. The apparatus 10 may comprise a torquing device 22, threaded rod 24, support frame 30, retractable portion 32, collar 36 and tensional coupler 38. In an embodiment, the torquing device 22 is generally disposed on the first end 26 of the threaded rod 24. The torquing device 22 may be any structure suitable for rotating and providing torque to the threaded rod 24, such as a driver nut, knob, handle, smooth or textured portion of the threaded rod 24 or the like. The torquing device 22 may be integral with the threaded rod 24 or a separate component attached to the threaded rod 24.

The threaded rod 24 may thread through the support frame 30 and terminate at a second end 28, and the second end 28 may be in a rotatably free relationship with the retractable portion 32. In one embodiment, the support frame 30 is capable of being positioned adjacent to a support wall 31. The support wall 31 can be integral with the object 14, such as an additional surface of a papermaking machine. In another nonlimiting example, the support wall 31 is connected to the object 14. In yet another nonlimiting example, the support wall 31 is separate from the object 14. In a further embodiment, as illustrated in FIG. 5, the support frame 30 comprises a rigid member 33. The rigid member 33 may provide an extension to facilitate positioning of the support frame 30 against the support wall 31. The support wall 31 may be part of the object 14 as shown in FIG. 5. In one nonlimiting example, the rigid member 33 extends substantially perpendicular from the support frame 30. In another nonlimiting example, the support frame 30 comprises a plurality of rigid members 33. In yet another nonlimiting example, the support frame 30 comprises two rigid members 33 which may be parallel to one another.

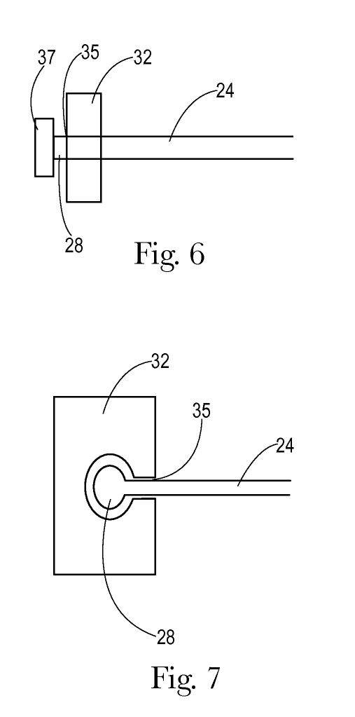

The second end 28 of the threaded rod 24 may be in a rotatably free relationship with the retractable portion 32. By rotatably free relationship, it is meant that the threaded rod 24 may be rotated about its central axis 34 without completely separating from the retractable portion 32. In other words, the threaded rod 24 remains associated with the retractable portion 32 while the threaded rod 24 is being rotated. In one nonlimiting example, the threaded rod 24 may be rotated about its central axis 34 without causing the retractable portion 32 to rotate. The threaded rod 24 may be integral with the retractable portion 32 or it may be a separate component that is joined with the retractable portion 32. In an embodiment, the threaded rod 24 is disposed within an opening 35 within the fixed member 32. The opening 35 may comprise a slot, hole, groove, aperture or any other means to permit the threaded rod 24 to be in a rotatably free relationship with the fixed member 32. In one nonlimiting example shown in FIG. 6, the threaded rod 24 is attached to the retractable portion 32 through a nut and/or washer 37 that is larger than the opening 35, such that the nut and/or washer 37 prevents the threaded rod 24 from disjoining from the retractable portion 32 when the threaded rod 24 is moved in a first direction, FD. In another nonlimiting example shown in FIG. 7, the retractable portion 32 and threaded rod 24 are associated through a ball joint, wherein the second end 28 of the threaded rod 24 fits within the opening 35 of the retractable portion 32 and is shaped such that it—the second end 28—cannot be pulled out through the opening 35 when the threaded rod 24 is moved in a first direction, FD.

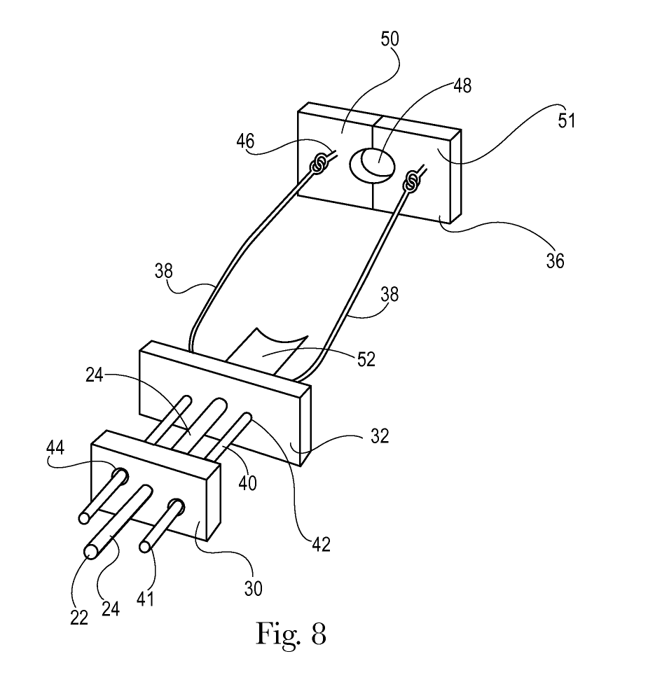

In one embodiment (as shown in FIGS. 1 and 8), the apparatus 10 may further comprise a stabilizing rod 40. The stabilizing rod 40 may have a leading end 41 and a tail end 42. In one nonlimiting example, the support frame 30 has an opening 44, and the stabilizing rod 40 may extend through the opening 44. The stabilizing rod 40 may be capable of sliding or otherwise moving through the opening 44 of the support frame 30. The opening 44 may comprise a slot, hole, groove, aperture or any other means to permit movement of the stabilizing rod 40 through or within the support frame 30. The tail end 42 of the stabilizing rod 40 may be associated with the retractable portion 32. The tail end 42 may be joined to the retractable portion 32 or integral with the retractable portion 32. Alternatively, the stabilizing rod 40 may be capable of sliding or otherwise moving through an opening of the retractable portion 32 and the stabilizing rod 40 may be associated with the support frame 30. In an embodiment, the apparatus 10 comprises a plurality of stabilizing rods 40; for example, two stabilizing rods 40. Without being bound by theory, it is believed that stabilizing rods 40 mitigate tipping of the support frame 30 (i.e., increasing or decreasing angle α) while the apparatus 10 is in use. It is further believed that the stabilizing rods 40 may also inhibit or prevent twisting of the support frame 30 and/or the retractable portion 32. In one nonlimiting example, the stabilizing rod 40 is made from carbon steel. In one embodiment, where a plurality of stabilizing rods 40 are used, each stabilizing rod 40 may be made of the same material, different material or combinations thereof.

The retractable portion 32 of the present invention may be associated with the tail end 42 of the stabilizing rod 40 and/or the second end 28 of the threaded rod 24. In addition, the retractable portion 32 may be connected to the collar 36 through the tensional coupler 38. In one embodiment, the collar 36 is connected to the retractable portion 32 by a plurality of tensional couplers 38. In another nonlimiting example, the collar 36 is connected to the retractable portion 32 by two tensional couplers 38.

In one nonlimiting example, the tensional coupler 38 is threaded through or otherwise connected through eye bolts 46 disposed on the retractable portion 32 and/or the collar 36. In another nonlimiting example, the tensional coupler 38 is integral with the retractable portion 32 and/or the collar 36. In yet another nonlimiting example, the tensional coupler 38 may be removable from the retractable portion 32 and/or from the collar 36. The tensional coupler 38 may be made of any material suitable for pulling the collar 36 by withstanding the amount of tension sufficient to remove a shaft 12 in accordance with the present disclosure. In one embodiment, the tensional coupler 38 is flexible. In another embodiment, the tension coupler 38 is pliant. The tensional coupler 38 can be folded, wrapped and/or wound. In a further embodiment, the tensional coupler 38 may be capable of being loose and/or having slack and also capable of providing sufficient tension to extract a shaft 12 according to the present disclosure. The flexibility and/or pliability of the tensional coupler 38 allows for the apparatus 10 to be used to extract shafts 12 of different sizes, including very long shafts, and permits the apparatus 10 to be easily stored. In one nonlimiting example, the tensional coupler 38 is about 100 inches. In another nonlimiting example, the tensional coupler 38 may be greater than about 80 inches, or greater than about 90 inches or greater than about 100 inches. Suitable materials for the tensional coupler 38 include but are not limited to stainless wire, metal rope, piano wire, and/or cable. In one embodiment, where a plurality of tensional couplers 38 are used, each tensional coupler 38 may be made of the same material, different material or combinations thereof. Further, where a plurality of tensional couplers 38 are used, each tensional coupler 38 may be associated with the collar 36 and/or retractable portion 32 in the same manner, different manners or a combination thereof.

The collar 36 is capable of grasping the engagement portion 20 of the shaft 12. In one nonlimiting example, the collar 36 comprises an opening 48, as shown in FIGS. 2 and 8. The opening 48 may be adjustable to fit over differently sized shafts 12. The opening 48 may comprise a slot, hole, groove, aperture or any other means to permit grasping of the shaft 12. In one nonlimiting example, the collar 36 comprises more than one piece, which fit together. As shown in FIG. 8, the collar 36 may comprise a first piece 50 and second piece 51 which fit together to form an opening 48 therein. The collar 36 may be in the form of a split collar.

The collar 36 may be capable of grasping the engagement portion 20 of the shaft 12 by a number of means, including but not limited to pressure fitting, mechanical fit means such as lock and key and/or or male/female connections, forceps or pincher type grips, clampers and/or the like. Alternatively, the engagement portion 20 may extend outwardly from the surface of the shaft 12 and the collar 36 may abut against it, such that the engagement portion 20 acts as a barrier to the collar 36 sliding down or otherwise moving along the shaft 12 in at least one direction. In another embodiment, the engagement portion 20 may extend inwardly from the surface of the shaft 12 and the collar 36 may abut against it, such that the engagement portion 20 acts as a barrier to the collar 36 sliding down or otherwise moving along the shaft 12 in at least one direction. Essentially, the engagement portion 20, more particularly the shape of the engagement portion 20, may interfere with the movement of the collar 36, causing the collar 36 to apply a direct force on engagement portion 20. In yet another embodiment, the collar 36 may be capable of grasping the engagement portion 20 through frictional engagement. In one nonlimiting example, the engagement portion 20 may have a smooth surface and the collar 36 may grasp the engagement portion 20 tightly enough to resist slippage between the two components.

In one embodiment, the apparatus 10 further comprises a support tray 52 as can be seen in FIG. 8. The support tray 52 may be capable of supporting the shaft 12. Without being bound by theory, it is believed that the support tray 52 can prevent the shaft 12 from tipping or falling once extracted from the object 14. In one nonlimiting example, the support tray 52 is made from carbon steel. In one embodiment, the support tray 52 may be positioned along a portion of the distal end 18 of the shaft 12. In another nonlimiting example, the support tray 52 has a shape that is complementary to or substantially similar to the surface of the shaft 12 or the shaft's distal end 18. For example, the support tray 52 may be curved to match the surface of a cylindrical shaft 12 or cylindrical distal end 18. In an embodiment, the support tray 52 may substantially surround the shaft 12 or a portion of the shaft 12, such as the distal end 18. The support tray 52 may be positioned along the bottom (or floor-side) of the shaft 12. The support tray 52 may extend a distance suitable for supporting the shaft 12 through all or part of the duration of the extraction. The support tray 52 may be attached to the retractable portion 32, the threaded rod 24, the collar 36, the object 14, the stabilizing rod 40, and/or combinations thereof.

The various components of the apparatus 10 as discussed herein may be made from any material suitable for extracting a shaft 12 according to the present disclosure, including but not limited to steel and/or rubber.

### Method for Extracting the Shaft

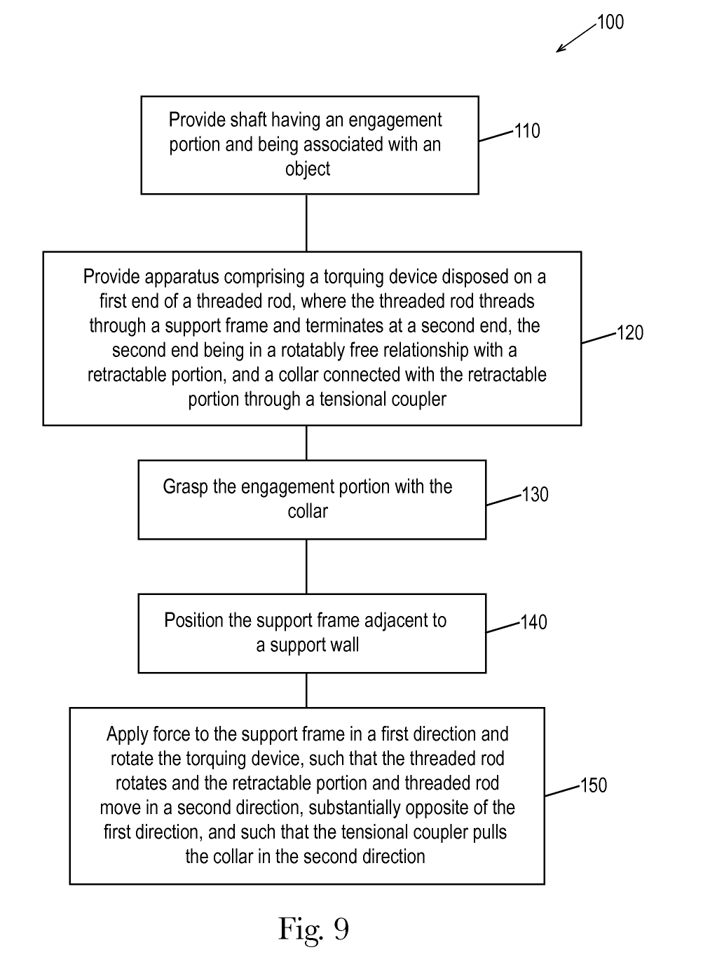

In one embodiment of the present invention, a method 100 for extracting a shaft 12 from an object 14 is provided. A schematic illustration of the steps that may be involved is shown in FIG. 9. Generally, the method 100 may involve providing a shaft 12 associated with an object 14, providing an apparatus 10 for the extraction which may be the apparatus 10 disclosed more fully above, grasping an engagement portion 20 of the shaft 12 with the collar 36, positioning the support frame 30 adjacent to a support wall 31, and applying force to the support frame 30 in a first direction, FD, while rotating the torquing device 22. The steps may be performed in the order disclosed or in any other order suitable for removing a shaft 12 from an object 14.

Referring to FIG. 9, an initial step 110 may include providing a shaft 12 associated with an object 14. The shaft comprises an engagement portion 20. As described more completely above, the engagement portion 20 may be of any shape, size or texture or material suitable to provide an area for the collar 36 to grasp. Nonlimiting examples of suitable engagement portions 20 include portions of the shaft 12 having their diameters, circumferences, perimeters, cross-sectional areas, and/or textures differing from portions of the shaft 12 immediately adjacent thereto. In one embodiment, the shaft 12 is a mandrel. In another embodiment, the object 14 is a machine used in a fibrous structure making process, including but not limited to an unwind stand.

In one nonlimiting example, the method 100 may include a step 120 of providing an apparatus 10. The apparatus 10 may be in the same form as described in the previous section above. The apparatus 10 may comprise a torquing device 22, a threaded rod 24, a support frame 30, a retractable portion 32, a tensional coupler 38 and a collar 36. The torquing device 22 may be disposed on a first end 26 of the threaded rod 24. The threaded rod 24 may thread through the support frame 30 and may terminate at a second end 28. The second end 28 of the threaded rod 24 may be in a rotatably free relationship with the retractable portion, rotatably free relationship having the same meaning as discussed above. The retractable portion 32 and the collar 36 may be connected through the tensional coupler 38. In one embodiment, the collar 36 is connected to the retractable portion 32 by a plurality of tensional couplers 38. In a nonlimiting example, the collar 36 is connected to the retractable portion 32 by two tensional couplers 38. As disclosed more fully above, the tensional coupler 38 may be made of any material suitable for pulling the collar 36 and/or withstanding an amount of tension sufficient to remove a shaft 12 in accordance with the present disclosure. Nonlimiting examples of tensional couplers 38 include stainless wire, metal rope, piano wire, and/or cable.

The method 100 may further include a collar grasping step 130. In the collar grasping step 130, the collar 36 may be used to grasp the engagement portion 20. As discussed more fully above, the collar 36 may grasp the engagement portion 20 by a number of means, including but not limited to pressure fitting, mechanical fit means such as lock and key and/or or male/female connections, forceps or pincher type grips, clampers and the like. In one nonlimiting example, the collar 36 comprises an opening 48, and the opening 48 is pressure fitted with the engagement portion 20. Alternatively, the engagement portion 20 may extend outwardly from the surface of the shaft 12 and the collar 36 may abut against it, such that the engagement portion 20 acts as a barrier to the collar 36 sliding down or otherwise moving along the shaft 12.

The method 100 may additionally include a positioning step 140, wherein the support frame 30 is positioned adjacent to a support wall 31. The support wall 31 can be integral with or connected to the object 14, or the support wall 31 may be separate from the object 14.

The method 100 may also include a force step 150. In the force step 150, force is applied to the support frame 30 in a first direction, FD (as shown in FIG. 1). The torquing device 22 is rotated such that the threaded rod 24 moves in a second direction, SD. The second direction, SD, may be substantially opposite to the first direction, FD. In one nonlimiting example, the torquing device 22 is rotated at the same or substantially the same time as the force is applied in a first direction, FD. Without being bound by theory, it is believed that the force in the first direction, FD, in combination with the torque will cause the apparatus 10 to extract the shaft 12 in the following manner: the torque will cause the threaded rod 24 to move in the second direction, SD. The retractable portion 32 (to which the threaded rod 24 is connected) will also move in the second direction, SD. The movement of the retractable portion 32 will cause the tensional coupler 38 to stretch and pull the collar 36 in the second direction, SD.

In one nonlimiting example, the engagement portion 20 prevents the collar 36 from moving in the second direction, SD, beyond the engagement portion 20.

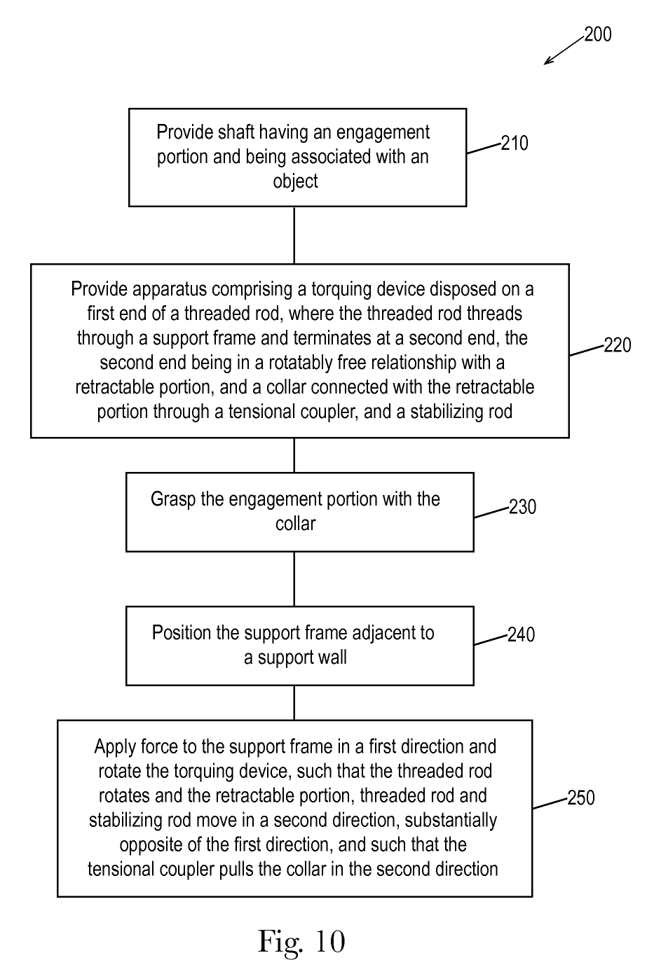

FIG. 10 illustrates a second embodiment of a method 200 according to the present invention. The method 200 may include an initial step 210, apparatus step 220, collar grasping step 230, positioning step 240 and force step 250 similar to the steps above. The apparatus 10, however, may further comprise a stabilizing rod 40 or a plurality of stabilizing rods 40. The stabilizing rod 40 may have a leading end 41 and a tail end 42. The leading end 42 may extend through an opening 44 in the support frame 30 and the tail end 42 may be associated with the retractable portion 32 as discussed in more detail above in the previous section. Alternatively, the stabilizing rod 40 may extend through an opening in the retractable portion and be associated, e.g., in a fixed manner, with the support frame 30. The force step 250 may further comprise the stabilizing rod 40 moving in the second direction, SD.

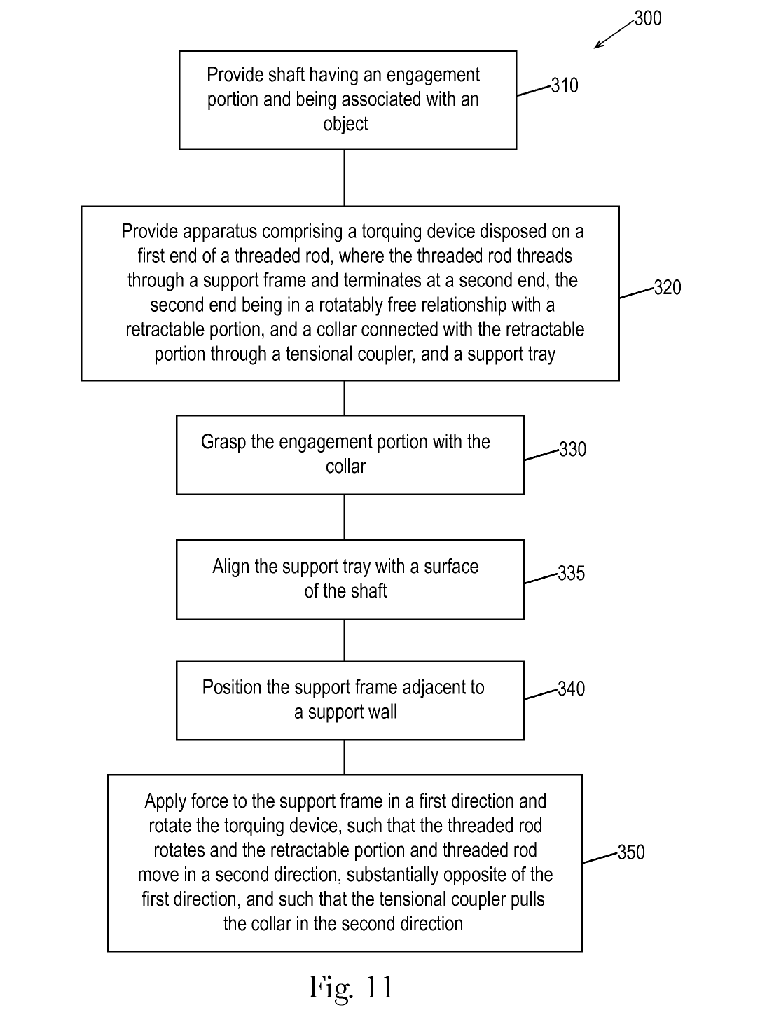

In yet another embodiment, a method 300 shown in FIG. 11 is provided. The method may include an initial step 310, apparatus step 320, collar grasping step 330, aligning step 335, positioning step 340 and force step 350. In this embodiment, the apparatus 10 may further comprise a support tray 52 capable of supporting the shaft 12 at the shaft's distal end 18. As discussed in the previous section, the support tray 52 may be attached to retractable portion 32, threaded rod 24, collar 36, object 14, stabilizing rod 40 or combinations thereof. The aligning step 335 may comprise aligning the support tray 52 with a surface of the shaft 12. In an embodiment, the support tray 52 may substantially surround the shaft 12 or a portion of the shaft 12, such as the distal end 18 or a portion of the distal end 18. The support tray 52 may be positioned along the bottom (or floor-side) of the shaft 12. In one nonlimiting example, the support tray 52 has a shape that is complementary to or substantially similar to the surface of the shaft 12 or the distal end 18, or a portion of the shaft 12 or the distal end 18. In another nonlimiting example, the support tray 52 may extend a distance suitable for supporting the shaft 12 through all or part of the duration of the extraction.

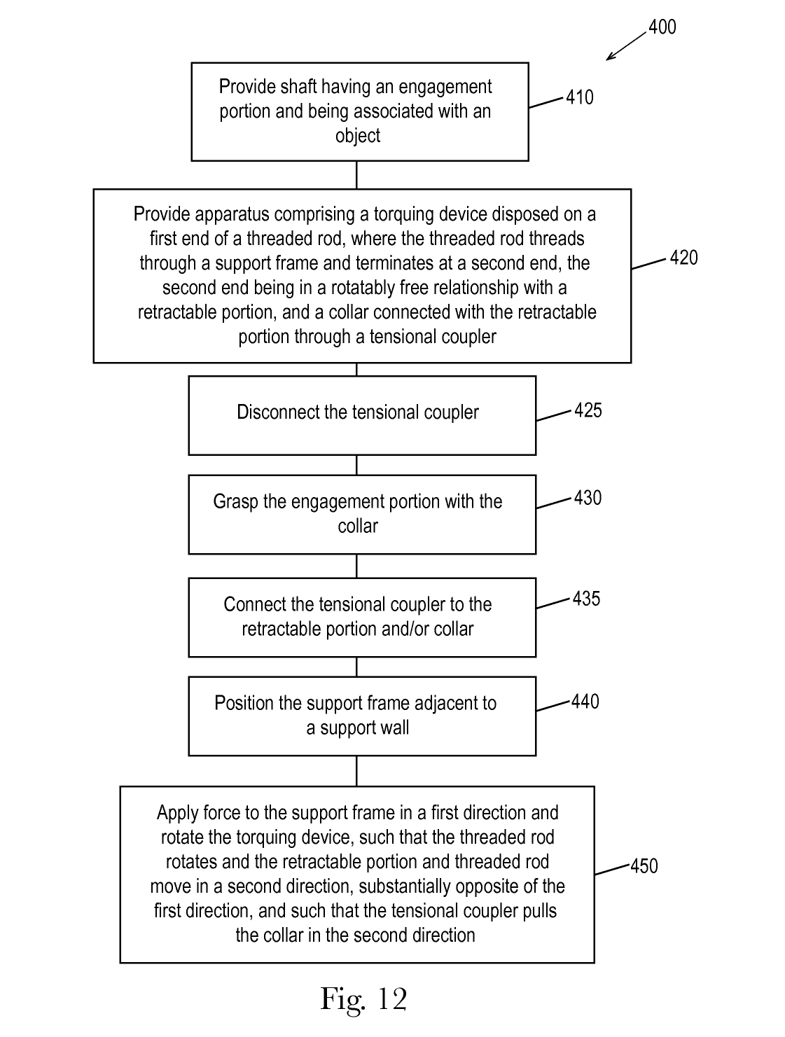

In still another embodiment, shown in FIG. 12, a method 400 wherein the tensional coupler 38 of the apparatus 10 may be removable is provided. The method 400 may include an initial step 410, apparatus step 420, disconnecting step 425, collar grasping step 430, reconnecting step 435, positioning step 440 and force step 450. The disconnecting step 425 may involve disconnecting or detaching the tensional coupler from the retractable portion 32 and/or the collar 36. The method 400 may also include a reconnecting step 435, in which the tensional coupler 38 is reconnected to the retractable portion 32 and/or the collar 36.

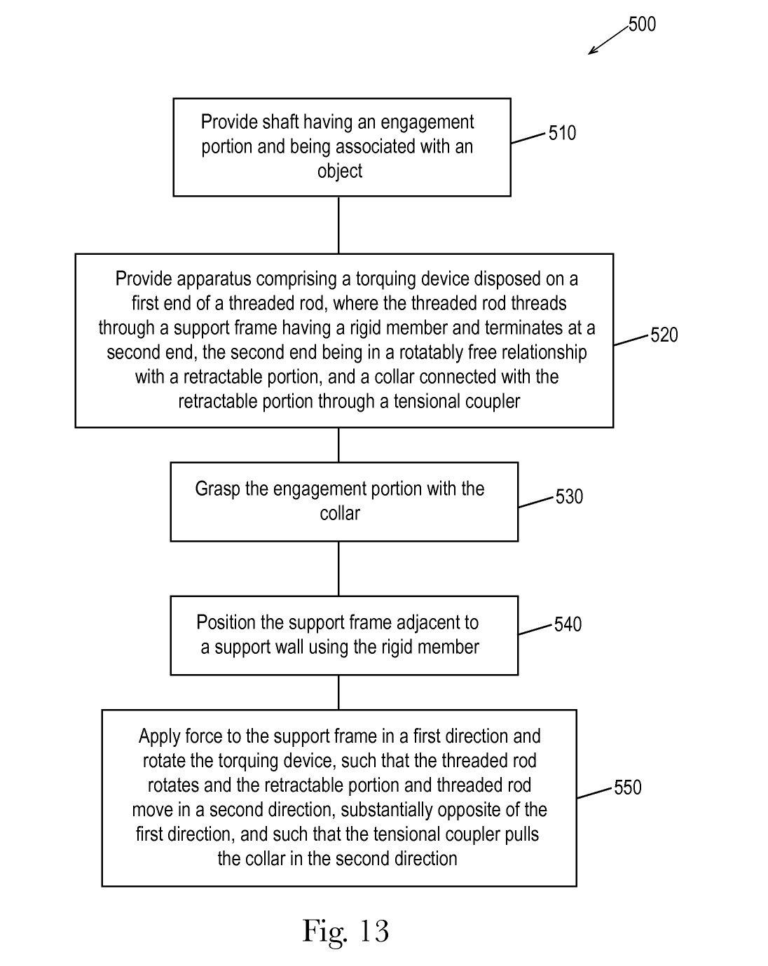

In another embodiment, shown in FIG. 13, the method 500 may include an initial step 510, apparatus step 520, collar grasping step 530, positioning step 540 and force step 550. In the apparatus step 520, the support frame 30 of the apparatus 10 may have a rigid member 33 or a plurality of rigid members 33. In one nonlimiting example, the rigid member 33 extends substantially perpendicularly from the support frame 30. The rigid member 33 may serve as an extension or arm from the support frame 30, allowing the support frame 30 to reach a support wall 31. The positioning step 540 may include associating the rigid member 33 or a plurality of rigid members 33 with the support wall 31.

The steps of any of the disclosed embodiments may be performed in the order disclosed or in any other order suitable for removing a shaft 12 from an object 14.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An apparatus for extracting a shaft from an object, the apparatus comprising:
a torquing device disposed on a first end of a threaded rod, wherein the threaded rod threads through a support frame and terminates at a second end, wherein the second end is in a rotatably free relationship with a retractable portion; and
a collar connected to the retractable portion through a tensional coupler and capable of grasping the shaft at an engagement portion of the shaft.

2. The apparatus of claim 1 further comprising a stabilizing rod having a leading end and tail end, wherein the support frame comprises an opening and the stabilizing rod extends through the opening of the support frame and wherein the tail end of the stabilizing rod is associated with the retractable portion.

3. The apparatus of claim 2 further comprising a support tray capable of supporting the shaft at a distal end of the shaft and being attached to one of the group consisting of: the threaded rod, the retractable portion, the collar, the object, the stabilizing rod and combinations thereof.

4. The apparatus of claim 1 wherein the shaft is a mandrel.

5. The apparatus of claim 4 wherein the object is a machine used in a fibrous structure making process.

6. The apparatus of claim 1 wherein the collar comprises an opening, wherein the opening of the collar is capable of pressure fitting over the shaft.

7. The apparatus of claim 1 wherein the tensional coupler is removable.

8. The apparatus of claim 1 wherein the support frame further comprises a rigid member extending from the support frame and having a distal end capable of associating with the support wall.

9. The apparatus of claim 8 wherein the rigid member extends substantially perpendicularly from the support frame.

10. A method for removing a shaft from an object, the method comprising the steps of:
a. Providing the shaft associated with the object, wherein the shaft comprises an engagement portion;
b. Providing an apparatus comprising a torquing device, a threaded rod, a support frame, a retractable portion, a tensional coupler and a collar, wherein:
the torquing device is disposed on a first end of the threaded rod,
the threaded rod threads through a support frame and terminates at a second end,
the second end is in a rotatably free relationship with the retractable portion, and
the collar is connected with the retractable portion through a tensional coupler;
c. grasping the engagement portion with the collar;
d. positioning the support frame adjacent to a support wall; and
e. applying force to the support frame in a first direction and rotating the torquing device, such that the threaded rod rotates and the threaded rod and the retractable portion move in a second direction, wherein the second direction is substantially opposite to the first direction, and wherein the tensional coupler pulls the collar in the second direction.

11. The method of claim 10 wherein:
the apparatus further comprises a stabilizing rod having a leading end and tail end, wherein the support frame comprises an opening and the stabilizing rod extends through the opening in the support frame and wherein the tail end of the stabilizing rod is associated with the retractable portion; and
the step of applying force further comprises the stabilizing rod moving in the second direction through the opening in the support frame.

12. The method of claim 11 wherein:
the apparatus further comprises a support tray being attached to one of the group consisting of: the threaded rod, the retractable portion, the collar, the object, the stabilizing rod and combinations thereof; and
the method further comprises the step of aligning the support tray with a surface of the shaft.

13. The method of claim 10 wherein the shaft is a mandrel.

14. The method of claim 10 wherein the object is a machine used in a fibrous structure making process.

15. The method of claim 10 wherein the collar comprises an opening, wherein the step of grasping the engagement portion with the collar further comprises pressure fitting the opening of the collar with the shaft.

16. The method of claim 9, wherein the tensional coupler is removable and the method further comprises the steps of: disconnecting the tensional coupler from one of the group consisting of the retractable portion and collar; and reconnecting the tensional coupler to the one of the group consisting of the retractable portion and collar.

17. The method of claim 10 wherein the support frame further comprises a rigid member extending from the support frame and having a distal end capable of associating with the support wall and wherein the step of positioning the support frame with the object further comprises associating the rigid member with the support wall.

18. The method of claim 17 wherein the rigid member extends substantially perpendicularly from the support frame.
